(19) United States
(12) Patent Application Publication
(10) Pub. No.: US 2025/0111678 A1
(43) Pub. Date: Apr. 3, 2025

(54) ESTIMATION DEVICE AND ESTIMATION METHOD

(71) Applicants: DENSO CORPORATION, Kariya-city (JP); TOYOTA JIDOSHA KABUSHIKI KAISHA, Toyota-shi (JP); MIRISE Technologies Corporation, Nisshin-shi (JP)

(72) Inventors: NOBUAKI MATSUDAIRA, Nisshin-shi (JP); TOMOHIRO NEZUKA, Nisshin-shi (JP)

(21) Appl. No.: 18/889,992

(22) Filed: Sep. 19, 2024

(30) Foreign Application Priority Data
Sep. 29, 2023 (JP) 2023-168956

(51) Int. Cl. G06V 20/56; G06T 7/70; G06V 10/44

(52) U.S. Cl. CPC G06V 20/56; G06T 7/70; G06V 10/44; G06T 2207/30252

(57) ABSTRACT

An estimation device is configured to: calculate a position and an orientation of a vehicle, using a self-position estimation method including Visual Odometry, based on sequential two-dimensional images of outside of the vehicle captured by a same camera, which is at least one of a plurality of cameras provided on the vehicle; obtain a bird's-eye view (BEV) feature, which is a feature in a BEV space, based on the two-dimensional images of the outside of the vehicle using a BEV estimation algorithm; and correct the obtained BEV feature using information representing the position and the orientation.

### CROSS REFERENCE TO RELATED APPLICATION

The present application claims the benefit of priority from Japanese Patent Application No. 2023-168956 filed on Sep. 29, 2023. The entire disclosures of the above application are incorporated herein by reference.

### TECHNICAL FIELD

The present disclosure relates to an estimation device and an estimation method.

### BACKGROUND

For example, it has been known a technology in which three-dimensional spatial information (bird's-eye view (BEV) features) is estimated using a machine learning model based on two-dimensional images acquired by multiple cameras mounted on a vehicle, and a bird's-eye view is generated based on the estimated three-dimensional spatial information.

### SUMMARY

The present disclosure describes an estimation device and an estimation method. According to an aspect, an estimation device is configured to: calculate a position and an orientation of a vehicle by using a self-position estimation method including a visual odometry based on sequential two-dimensional images representing outside of a vehicle captured by a same camera, which is at least one of a plurality of cameras mounted on the vehicle; obtain a bird's-eye view (BEV) feature, which is a feature in a BEV space, based on the two-dimensional images representing outside of the vehicle by using a BEV estimation algorithm; and correct the obtained BEV feature using information representing the position and the orientation.

### BRIEF DESCRIPTION OF THE DRAWINGS

Objects, features and advantages of the present disclosure will become more apparent from the following detailed description made with reference to the accompanying drawings, in which:

FIG. 1 is a block diagram illustrating a schematic configuration of a driving assistance system;

FIG. 2 is an explanatory diagram illustrating an example of camera arrangement;

FIG. 3 is an explanatory diagram illustrating coordinate transformation;

FIG. 4 is a flowchart illustrating a method for generating a bird's-eye view according to a first embodiment;

FIG. 5 is a flowchart illustrating a method for generating a bird's-eye view according to a second embodiment;

FIG. 6 is a flowchart illustrating a method for generating a bird's-eye view according to a third embodiment;

FIG. 7 is a flowchart illustrating a method for generating a bird's-eye view according to a fourth embodiment;

FIG. 8 is a flowchart illustrating a method for generating a bird's-eye view according to a fifth embodiment;

FIG. 9 is a flowchart illustrating a method for generating a bird's-eye view according to a seventh embodiment;

FIG. 10 is a flowchart illustrating a position and orientation calculation process in FIG. 9;

FIG. 11 is a flowchart illustrating a method for generating a bird's-eye view according to an eighth embodiment; and

FIG. 12 is a flowchart illustrating a position and orientation calculation process in FIG. 11.

### DETAILED DESCRIPTION

For example, there is a technology in which a bird's-eye view is generated based on three-dimensional spatial information (BEV features) estimated using a machine learning model based on two-dimensional images acquired by multiple cameras mounted on a vehicle. In such a technology, the three-dimensional spatial information (BEV features) may be adjusted using vehicle motion information. As the vehicle motion information, acceleration, speed, yaw rate, and the like detected by various sensors provided in the vehicle may be used.

These various sensors transmit detection values via a controller area network (CAN) bus to an electronic control unit (ECU) that generates a bird's-eye-view image. Since multiple ECUs and the like are connected to the CAN bus, communication delays are likely to occur with the increase in the communication load on the CAN bus.

The multiple cameras for capturing two-dimensional images are individually connected via Ethernet (registered trademark) to the ECU that generates the bird's-eye-view image. For this reason, there is almost no time lag between the timing at which the ECU, which generates the bird's-eye-view image, receives the image captured by the camera and the timing at which the camera transmits the captured image.

On the other hand, if communication delays occur on the CAN bus, there will be large time lags between the timings at which the ECU, which generates the bird's-eye-view image, receives the detection values from the various sensors and the timings at which the various sensors transmit their detection values. It is desirable that the ECU, which generates the bird's-eye-view image, acquires the two-dimensional image from the camera at the same time as obtaining the detection values from the sensors. However, synchronization errors are likely to occur in adjusting the BEV features due to the communication delays on the CAN bus. Therefore, there is a need for technology that can reduce the influence of synchronization errors in adjusting the BEV features.

According to an aspect of the present disclosure, an estimation device includes: a position calculation unit configured to calculate a position and an orientation of a vehicle by using a visual odometry as a self-position estimation method based on sequential two-dimensional images representing outside of a vehicle captured by a same camera, which is at least one a plurality of cameras mounted on the vehicle; a feature obtaining unit configured to obtain a bird's-eye view (BEV) feature, which is a feature in a BEV space, based on the two-dimensional images of the outside of the vehicle using a BEV estimation algorithm; and a correction unit configured to correct the BEV feature obtained by the feature obtaining unit using information representing the position and the orientation.

According to the estimation device described above, the position and the orientation of the vehicle are estimated by using the visual odometry based on the images captured by the camera, which is less affected by communication delays compared to sensors connected to the ECU via a CAN bus, and the BEV feature is corrected using the information representing the estimated position and orientation. As such, the influence of synchronization errors can be reduced, as compared to a configuration in which the BEV feature is corrected using detection values from the sensors connected to the ECU via the CAN bus.

Embodiments of the present disclosure will be described hereinafter with reference to the drawings.

### First Embodiment

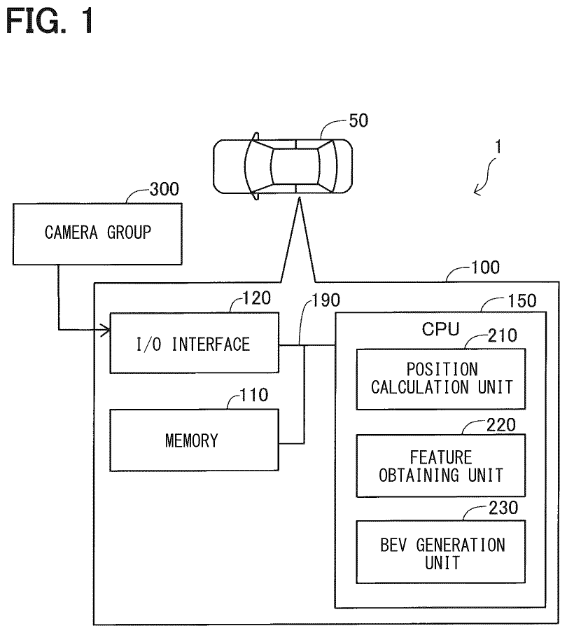

A driving assistance system 1 shown in FIG. 1 estimates the surroundings of a vehicle 50 using multiple two-dimensional images acquired sequentially by an image sensor provided on the vehicle 50, and generates a bird's-eye-view image of the vehicle 50 as viewed from above. The bird's-eye-view image is an image showing an overhead view of the vehicle 50, that is, an image when looking down on the vehicle 50 from above. For example, the driving assistance system 1 uses multiple two-dimensional images acquired sequentially by the image sensor mounted on the vehicle 50 and causes an in-vehicle monitor device mounted on the vehicle 50 to display an image looking down on the vehicle 50 from above. The vehicle 50 is equipped with an advanced driving assistance system (ADAS) and can be driven thereby.

The driving assistance system 1 includes an estimation device 100 and a camera group 300. The estimation device 100 and the camera group 300 are mounted on the vehicle 50.

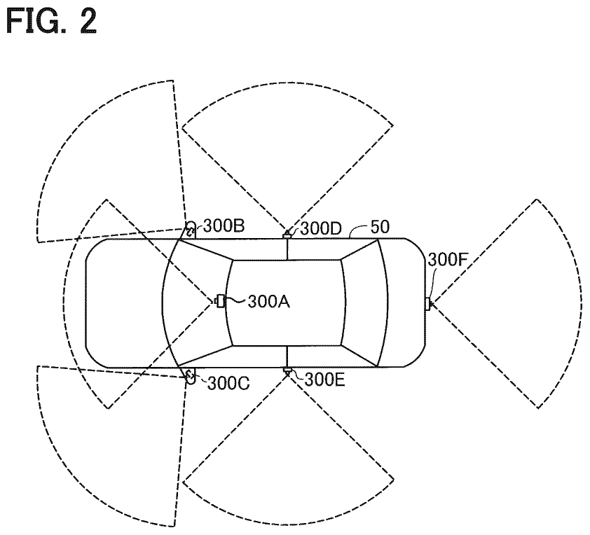

As shown in FIG. 2, the camera group 300 includes six cameras 300A to 300F mounted on the vehicle 50. The cameras 300A to 300F are monocular cameras capable of capturing color images. The camera 300A is disposed at an upper part of a windshield of the vehicle 50. The camera 300A captures an image of a predetermined range in front of vehicle 50. The camera 300B is disposed at a lower part of a door mirror on a right side of the vehicle 50. Hereinafter, the right side of the vehicle 50 refers to the right side as seen by a person sitting inside the vehicle 50 facing the front of the vehicle 50. The camera 300B captures an image of a predetermined range diagonally forward to the right of the vehicle 50.

The camera 3000 is disposed at a lower part of a door mirror on a left side of the vehicle 50. The left side of the vehicle 50 refers to the left side as seen by a person sitting inside the vehicle 50 facing the front of the vehicle 50. The camera 3000 captures an image of a predetermined range diagonally forward to the left of the vehicle 50. The camera 300D is disposed on a right door pillar of the vehicle 50. The camera 300D captures an image of a predetermined range on the right side of vehicle 50. The camera 300E is disposed on a left door pillar of the vehicle 50. The camera 300E captures an image of a predetermined range on the left side of the vehicle 50. The camera 300F is disposed at the center of a back door of the vehicle 50. The camera 300F captures an image of a predetermined range behind the vehicle 50.

The cameras 300A to 300F each capture images of the respective predetermined range outside the vehicle 50 at a predetermined frame rate and output the captured images to the estimation device 100. In the present embodiment, it is assumed that the cameras 300A to 300F capture images at the same timing, for ease of understanding of the technology.

The estimation device 100 is a computer including a memory 110, an input/output interface 120, and a central processing unit (CPU) 150. The memory 110 and the input/output interface 120 are connected to the CPU 150 via a bus 190. For example, functions of the estimation device 100 are realized by a driving-control electronic control unit (ECU) that is responsible for driving control of the vehicle 50.

The memory 110 stores various programs and various data used for various processing executed by the estimation device 100. The memory 110 stores data representing machine learning models used in various processing executed by the estimation device 100.

The cameras 300A to 300F are connected to the input/output interface 120 via Ethernet (registered trademark).

The CPU 150 is a processor that realizes various functions by executing the programs stored in the memory 110. For example, the CPU 150 stores in the memory 110 the two-dimensional images received from the cameras 300A to 300F. In an embodiment, the CPU 150 executes the programs stored in the memory 110 to function as a position calculation unit 210, a feature obtaining unit 220, a correction unit 225, and a bird's-eye view generation unit 230.

The position calculation unit 210 calculates, based on sequential two-dimensional images and using a visual odometry as a self-position estimation method, a position and an orientation of the vehicle 50 and three-dimensional coordinates of objects in the two-dimensional images. In the present embodiment, the position calculation unit 210 calculates, using the visual odometry and based on the two-dimensional images captured by at least one of the cameras 300A to 300F, the position and orientation of the vehicle 50 and the three-dimensional coordinates of the objects present around the vehicle 50. The processing executed by the position calculation unit 210 will be described in detail later.

The feature obtaining unit 220 obtains bird's-eye view (BEV) features, which are features in a BEV space, based on the two-dimensional images of the outside of the vehicle 50 captured by the cameras 300A to 300F. The BEV features include coordinate values of a point cloud in a three-dimensional space and information on the color of the point cloud, similar to point cloud data detected by light detection and ranging (LiDAR). The processing executed by the feature obtaining unit 220 will be described in detail later.

The correction unit 225 corrects the BEV features generated by the feature obtaining unit 220 in accordance with the position and orientation of the vehicle 50. The processing by the correction unit 225 will be described in detail later.

The bird's-eye view generation unit 230 generates a bird's-eye view based on the BEV features. The bird's-eye view is an image showing the surroundings of the vehicle 50 as a top-down perspective as viewed the vehicle 50 from above. An existing method can be used to generate the bird's-eye view based on the BEV features. The bird's-eye view generation unit 230 can detect objects around the vehicle 50 based on the BEV features and generate the bird's-eye view showing the objects around the vehicle 50. It should be noted that the generated bird's-eye view does not necessarily include all objects around the vehicle 50. For example, the bird's-eye view generation unit 230 may detect lanes around the vehicle 50 based on the BEV features, and generate the bird's-eye view including the vehicle 50 and the lanes.

Next, the visual odometry (hereinafter, simply referred to as the VO) will be described. In the VO, feature points are detected in multiple sequential two-dimensional images, which are successive in time series, and the position and orientation of the vehicle 50 are estimated using the coordinates of the feature points in the two-dimensional images. The feature point is a point that can be reliably detected on an image.

The feature points are detected by using a corner detection technique. For example, the intersection of two edges is detected as a corner. Alternatively, a point where there are two distinct edges with different orientations in a local neighborhood is detected as a corner. Examples of the corner detection technique that can be used include a Harris corner detection, a scale-invariant feature transform (SHIFT), a speeded up robust features (SURF), and an Oriented FAST and rotated BRIEF (ORB). Further, many of the corner detection techniques can detect not only the corner points but also the feature points. The number of feature points detected from a single two-dimensional image is, for example, 100.

For example, feature points are detected from three sequential two-dimensional images captured by the same camera. The times at which the three sequential two-dimensional images are captured are referred to as t0, t1, and t2. The time t0 is the earliest time, and the time t2 is the latest time. The feature points are detected in each of the two-dimensional images acquired at the times t0, t1, and t2, and the coordinates and brightness value of each detected feature point are recorded. Examples of the detected feature points include corners of buildings, contours of traffic signs, boundaries of the color of the traffic signs, and corners of curbs.

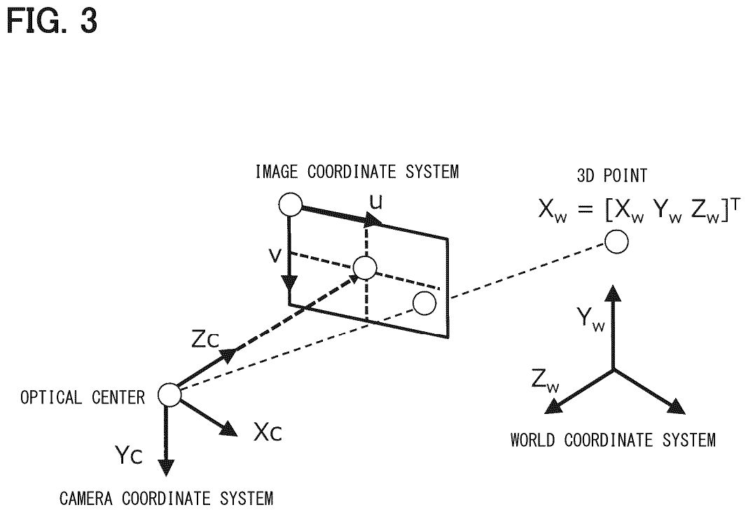

As shown in FIG. 3, the coordinates of the detected feature point are coordinates obtained by projecting a three-dimensional position of an object or the like in a world coordinate system onto an image coordinate system. The relationship between the coordinates in the two-dimensional image of the feature point and the three-dimensional position in the world coordinate system of the feature point can be expressed as the following mathematical formula (1). In the mathematical formula (1), fₓ and f_{y} represent focal lengths, cₓ and c_{y} represent the position of the intersection of an optical axis and a projection plane, r₁₁ to r₃₃ represent rotation matrix, t₁ to t₃ represent translation vectors, and s represents a scale factor. The scale factor s is estimated in advance using measurement results of the position and orientation of the camera using an inertial measurement unit (IMU) or the like.

$$\begin{matrix}[ Mathematical Formula 1 ] & \\ s [ \begin{matrix}u \\ v \\ 1\end{matrix} ] = [ \begin{matrix}{f}_{x} & 0 & {c}_{x} \\ 0 & {f}_{y} & {c}_{y} \\ 0 & 0 & 1\end{matrix} ] [ \begin{matrix}{r}_{11} & {r}_{12} & {r}_{13} & {t}_{1} \\ {r}_{21} & {r}_{22} & {r}_{23} & {t}_{2} \\ {r}_{31} & {r}_{32} & {r}_{33} & {t}_{3}\end{matrix} ] [ \begin{matrix}{X}_{W} \\ {Y}_{W} \\ {Z}_{W} \\ 1\end{matrix} ] & ( 1 )\end{matrix}$$

The mathematical formula (1) can be expressed in a form as shown by a mathematical formula (2).

$$\begin{matrix}[ Mathematical Formula 2 ] & \\ s {u}_{I} = K [ R T ] {X}_{W} & ( 2 )\end{matrix}$$

In the mathematical formula (2), the matrix K is called an intrinsic parameter of the camera. The matrix [R T] is called an extrinsic parameter of the camera. The extrinsic parameter of the camera is determined by the position T and orientation R in the camera coordinate system. As shown in the mathematical formula (2), the position u_{I}=[u v 1]^{t} in the two-dimensional image is expressed by a function of the position T and orientation R in the camera coordinate system and the position X_{w}=[X_{W} Y_{W} Z_{W}]^{t} in the world coordinate system.

When the position of the feature point corresponding to the same object or the like detected in multiple sequential two-dimensional images is tracked, the position of the feature point of interest changes with the movement of the vehicle 50, that is, the movement of the camera group 300.

In the VO, the position and orientation of the camera and the three-dimensional coordinates in the world coordinate system of the feature point at the time t1 are estimated based on the position of the feature point detected in each of the two-dimensional images by bundle adjustment. Specifically, the position and orientation of the camera and the three-dimensional coordinates in the world coordinate system of the feature point at the time t1 are calculated using the coordinates of corresponding feature points detected in the multiple two-dimensional images and the assumed camera position T and orientation R of the camera. The calculated three-dimensional coordinates are then re-projected onto the image coordinate system, and a distance (reprojection error) between the projected point and the feature point detected from the two-dimensional image is estimated.

The position u of the feature point in the two-dimensional image can be obtained by a projection function as shown in the following mathematical formula (3). It is assumed that the intrinsic parameter is fixed, and the intrinsic parameter is thus not taken into consideration in the mathematical formula (3). The projection function is a function that maps the coordinate system of the object space (i.e., the world coordinate system) to the coordinate system of the image space (i.e., the image coordinate system).

$$\begin{matrix}[ Mathematical Formula 3 ] & \\ {u}_{P} = proj ( R , T , {X}_{W} ) & ( 3 )\end{matrix}$$

The error between the position u_{I} of the feature point detected from the two-dimensional image and the position u_{P} of the feature point obtained from the projection function is defined as in the following mathematical formula (4). In the mathematical formula (4), u_{I} represents a set of coordinates of the feature points detected from the two-dimensional image.

$$\begin{matrix}[ Mathematical Formula 4 ] & \\ {C}_{c a m} = \vert {u}_{I} - proj ( R , T , {X}_{W} ) \vert & ( 4 )\end{matrix}$$

By an optimization processing that minimizes the error function C_{cam} expressed by the mathematical formula (4), the position and orientation of the camera and the three-dimensional coordinates in the world coordinate system of the feature point at the time t1 are estimated. The estimated position and orientation of the camera are expressed by a rotation matrix and a translation vector. Minimizing the error expressed by the mathematical formula (4) means minimizing the error between the actual coordinates in the image of the detected feature point and the coordinates of the feature point obtained by the projection function. In this way, in the VO, the position T and orientation R of the camera in the world coordinate system are estimated.

Next, a BEV estimation algorithm for estimating the BEV according to the present embodiment will be described.

In the present embodiment, a bird's-eye-view image is generated by combining the estimation results of the position and orientation of the vehicle 50 by the VO with an algorithm disclosed in US2023/0053785A1, which is incorporated herein by reference. In the algorithm disclosed in US2023/0053785A1, image features corresponding to respective multiple cameras are converted from an image space to a BEV space by using a machine learning model having a transformer architecture, thereby to obtain BEV features.

In the algorithm disclosed in US2023/0053785A1, first, two-dimensional images are acquired by multiple cameras, respectively. The image features are extracted from the respective two-dimensional images by using a backbone network. The backbone network is, for example, a convolutional neural network (CNN). The extracted image features are input into a transformer engine, which is the machine learning model having the transformer architecture. The transformer engine is a machine learning model that utilizes an attention mechanism. The transformer engine is a machine learning model that has been trained to take the image features extracted from the multiple two-dimensional images as input, fuse the image features, and project the image features onto the BEV space.

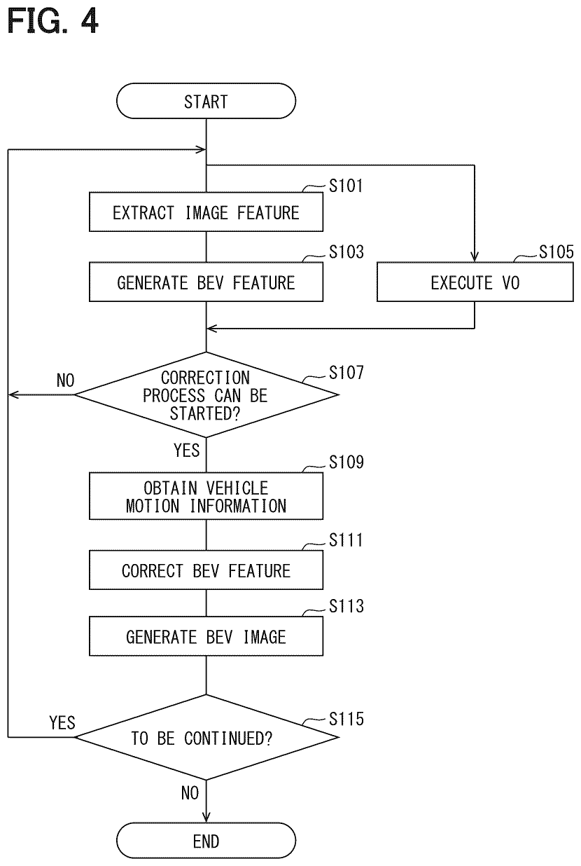

FIG. 4 shows a bird's-eye view estimation method executed by the estimation device 100 according to the present embodiment. For example, the process shown in FIG. 4 is started when an autonomous driving function is enabled. While the following process is being performed, the cameras 300A to 300F each capture images of a predetermined range outside the vehicle 50 at a predetermined frame rate and output the captured two-dimensional images to the estimation device 100. The two-dimensional images captured by the cameras 300A to 300F are sequentially stored in the memory 110.

In S101, the feature obtaining unit 220 extracts image features of the two-dimensional images. Specifically, the image features (feature vectors) of the two-dimensional images acquired by the camera 300A are extracted using a machine learning model such as CNN. The extracted image features of the two-dimensional images are stored in the memory 110. To extract the image features of the two-dimensional images captured by the camera 300A, a machine learning model that has been trained to output, when the two-dimensional images are input, the image features of the two-dimensional images is used. This machine learning model is generated by machine learning using, as learning data, two-dimensional images captured by a camera attached in a similar position to the camera 300A. Further, the image features of the two-dimensional images captured by the cameras 300B to 300F are extracted using the machine learning models, which have been correspondingly trained for the respective cameras 300B to 300F, by inputting the two-dimensional images captured by the respective cameras 300B to 300F thereto. The extracted image features of the two-dimensional images are stored in the memory 110.

In S101, for example, the image features of one set of two-dimensional images may be extracted. The one set of the two-dimensional images includes six two-dimensional images captured at the same time by the cameras 300A to 300F.

Alternatively, in S101, the image feature extraction processing may be performed on two-dimensional images included in a predetermined number of sets of two-dimensional images that have been stored in memory 110 and have not been subjected to the image feature extraction processing. The predetermined number is, for example, two. In this case, for example, when the processing of S101 is executed once, the image features of the two-dimensional images acquired by the respective cameras 300A to 300F at time tc1 and the image features of the two-dimensional images acquired by the respective cameras 300A to 300F at time tc1−1 are extracted. The time tc1 is the time when the two-dimensional images were acquired most recently. The time tc1−1 is the time when the two-dimensional images were acquired prior to the time tc1. No two-dimensional image is acquired between the time tc1−1 and the time tc1.

In S103, the feature obtaining unit 220 generates the BEV features in the BEV space using the transformer engine based on the image features extracted in S101. The generated BEV features are stored in the memory 110.

For example, in a case where the image features of one set of the two-dimensional images are extracted in S101, the BEV features are generated in S103 based on the image features of the one set of the two-dimensional images.

In S105, the position calculation unit 210 executes the VO. In the present embodiment, the position and orientation in the world coordinate system of the camera 300A are calculated by the VO based on the two-dimensional images captured by the camera 300A. The calculated position and orientation of the camera 300A are treated as the position and orientation of the vehicle 50. The processing of S101 and S103 and the processing of S105 are executed in parallel.

In S105, the positions and orientations of the vehicle 50 at two or more consecutive times may be calculated. In this case, when the processing of S105 is executed once, the positions and orientations of the vehicle 50 at the time tc1−1 and the time tc1 are calculated, for example.

In S107, it is determined whether or not the correction unit 225 can start a correction process. The correction process can be started when all of the following conditions (i) to (iv) are satisfied. Hereinafter, a current frame refers to the two-dimensional image acquired immediately before, and a previous frame refers to the two-dimensional image acquired before acquiring the current frame. No other frames are acquired between the acquisition of the current frame and the acquisition of the previous frame. (i) The BEV features have been generated based on the image features of the current frames acquired by the cameras 300A-300F, respectively. (ii) The BEV features have been generated based on the image features of the previous frames acquired by the cameras 300A-300F, respectively. (iii) The position and orientation of the vehicle 50 have been calculated based on the current frame. (iv) The position and orientation of the vehicle 50 have been calculated based on the previous frame.

When it is determined that the correction process can be started (S107: YES), S109 is executed. When it is not determined that the correction process can be started (S107: NO), S101 and S105 are executed again.

In S109, the correction unit 225 obtains motion information of the vehicle 50. The motion information of the vehicle 50 includes the amount of change of the position of the vehicle 50 and the amount of change of the orientation of the vehicle 50 between the time tc1 and the time tc1−1.

In S111, the correction unit 225 corrects the BEV features. Specifically, first, the BEV features based on the previous frame are aligned using the motion information of the vehicle 50. Then, the aligned BEV features are combined with the BEV features based on the current frame to obtain corrected BEV features. The corrected BEV features are stored in the memory 110. The corrected BEV features are used in a process of estimating the position of a vehicle in the current frame, for example, when the vehicle detected in the previous frame is not detected in the current frame due to the vehicle being hidden by another vehicle.

In S113, the bird's-eye view generation unit 230 generates a bird's-eye-view image based on, for example, the BEV features based on the current frame. The generated bird's-eye-view image is displayed, for example, on a monitor device provided in the vehicle 50.

In S115, it is determined whether or not to continue the process according to a predetermined condition. For example, it is determined that the process is to be continued while the autonomous driving function is enabled (S115: YES). In this case, the processing of S101 and S105 are executed again. For example, in a state where an abnormality in the sensor is detected, it is determined not to continue the process (S115: NO). In this case, the process shown in FIG. 4 ends. The processing of S115 is executed by, for example, the bird's-eye view generation unit 230.

In the present embodiment, as described above, the position and orientation of the vehicle 50 are estimated by the visual odometry using the images acquired by the camera that is less affected by communication delays, as compared to sensors connected to the ECU via a CAN bus, and the BEV features are corrected by using the information representing the estimated position and orientation. This method can reduce the influence of synchronization errors, as compared to a method in which the BEV features are corrected using detection values by the sensors connected to the ECU via the CAN bus.

### Second Embodiment

A driving assistance system 1 according to the second embodiment will be hereinafter described. The following description will focus on configurations that differ from the first embodiment. Description of configurations similar to those of the first embodiment will be omitted.

In the present embodiment, a bird's-eye-view image is generated by combining the estimation results of the position and orientation of the vehicle 50 by the VO with a machine learning model having an attention mechanism of UniFushion algorithm (Zequn Qin and 4 others, “UniFusion: Unified Multi-view Fusion Transformer for Spatial-Temporal Representation in Bird's-Eye-View”, arXiv, [online], [Retrieved on Sep. 4, 2023], Internet URL: https://arxiv.org/pdf/2207.08536).

In the UniFusion algorithm, the BEV features are obtained by converting the image features corresponding to the respective multiple cameras from the image space into the BEV space using machine learning models based on a virtual image in which the image features corresponding to the respective cameras previously acquired are generated using information of the position and orientation of the vehicle 50 and the image features corresponding to the respective cameras currently acquired. In the present embodiment, by generating the virtual image using the estimated results of the position and orientation of the vehicle 50 estimated by the VO, it is possible to eliminate the influence of synchronization errors between the cameras and the various sensors obtained via the CAN bus described above.

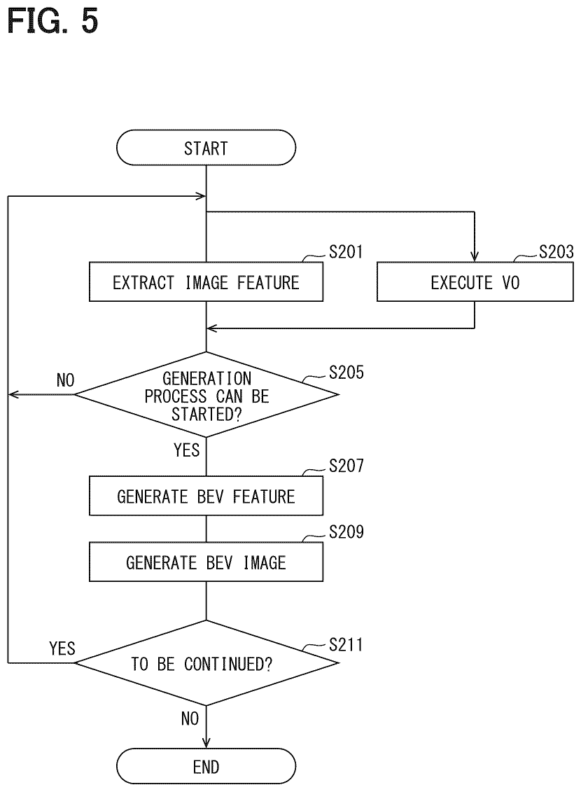

FIG. 5 shows a bird's-eye view estimation method executed by the estimation device 100 according to the present embodiment. While the following process is being performed, the cameras 300A to 300F each capture images of a predetermined range outside the vehicle 50 at a predetermined frame rate, and output the captured two-dimensional images to the estimation device 100. The two-dimensional images captured by the cameras 300A to 300F are sequentially stored in the memory 110.

In S201, the feature obtaining unit 220 extracts the image features of the two-dimensional images. Specifically, image features (feature vectors) of the two-dimensional images captured by the camera 300A are extracted using a machine learning model such as CNN. The extracted image features of the two-dimensional images are stored in the memory 110. To extract the image features of the two-dimensional images captured by the camera 300A, a machine learning model that has been trained to output, when the two-dimensional images are input, image features of the two-dimensional images is used. This machine learning model is generated by machine learning using, as learning data, two-dimensional images captured by a camera attached in a similar position to the camera 300A. Further, the image features of the two-dimensional images captured by the cameras 300B to 300F are extracted using the machine learning models, which have been correspondingly trained for the respective cameras 300B to 300F, by inputting the two-dimensional images captured by the respective cameras 300B to 300F thereto. The extracted image features of the two-dimensional images are stored in the memory 110.

In S201, the image features of one set of two-dimensional images may be extracted. The one set of the two-dimensional images includes six two-dimensional images captured at the same time by the cameras 300A to 300F.

Alternatively, in S201, the image feature extraction processing may be performed on two-dimensional images that are included in a predetermined number of sets of two-dimensional images stored in the memory 110 and have not been subjected to the image feature extraction processing.

In S203, the position calculation unit 210 executes the VO. In the present embodiment, the position and orientation of the camera 300A in the world coordinate system are calculated by the VO based on the two-dimensional images captured by the camera 300A. The processing of S201 and the processing of S203 are executed in parallel.

In S205, it is determined whether or not the generation process of the BEV features can be started. The generation process of the BEV features can be started when all of the following conditions (i) to (vi) are satisfied. Time tc2 is the time when the two-dimensional image was acquired most recently. Time tc2−1 is the time when two-dimensional image was acquired prior to the time tc2. No two-dimensional image is acquired between the time tc2−1 and the time tc2. Time tc2−2 is the time when the two-dimensional image was acquired prior to the time tc2−1. No two-dimensional image is acquired between the time tc2−2 and the time tc2−1. (i) The image features of the respective two-dimensional images acquired by the cameras 300A to 300F at the time tc2 have been extracted. (ii) The image features of the respective two-dimensional images acquired by the cameras 300A to 300F at the time tc2−1 have been extracted. (iii) The image features of the respective two-dimensional images acquired by the cameras 300A to 300F at the time tc2−2 have been extracted. (iv) The position and orientation of the vehicle 50 at the time tc2 have been calculated. (v) The position and orientation of the vehicle 50 at the time tc2−1 have been calculated. (vi) The position and orientation of the vehicle 50 at the time tc2−2 have been calculated.

When it is determined that the generation process of the BEV features can be started (S205: YES), the processing of S207 is executed. When it is not determined that the generation process can be started (S205: NO), the processing of S201 and S203 are executed again.

In S207, the feature obtaining unit 220 generates the BEV features in the BEV space using the attention network in the UniFusion algorithm described above, based on the image features of the respective two-dimensional images acquired by the cameras 300A to 300F and the information representing the position and orientation of the vehicle 50. The generated BEV features are stored in the memory 110. In the UniFusion algorithm, the BEV features are generated based on information obtained by converting the image features of the two-dimensional images captured by each camera at the time tc2−2 and the time tc2−1 into a virtual image at the time tc2 using the information representing the position and orientation of the vehicle, and the image features obtained at the time tc2.

In S209, the bird's-eye view generation unit 230 generates a bird's-eye-view image based on the BEV features. The generated bird's-eye-view image is displayed, for example, on a monitor device provided in the vehicle 50.

In S211, it is determined whether or not to continue the process according to a predetermined condition. For example, when the autonomous driving function is being enabled, it is determined that the process is to be continued (S211: YES). In this case, the processing of S201 and the processing of S203 are executed again. For example, in a state where an abnormality in the sensor is detected, it is determined not to continue the process (S211: NO). In this case, the process shown in FIG. 5 ends. The processing of S211 is executed by, for example, the bird's-eye view generation unit 230.

In the present embodiment, as described above, the position and orientation of the vehicle 50 are estimated by using the VO and the images acquired by the camera that is less affected by communication delays, as compared to sensors connected to the ECU via the CAN bus, and the BEV features are corrected using information representing the estimated position and orientation. This method can reduce the influence of synchronization errors, as compared to a method in which the BEV features are corrected using detection values by the sensors connected to the ECU via the CAN bus.

### Third Embodiment

A driving assistance system 1 according to a third embodiment will be hereinafter described. The following description will focus on configurations that differ from the first embodiment. Description of configurations similar to those of the first embodiment will be omitted.

In the present embodiment, the bird's-eye-view image is generated by combining the estimation results of the position and orientation of the vehicle 50 by the VO with a Lift Splat Shoot (LSS) algorithm (Jonah Philion, Sanja Fidler, “Lift, Splat, Shoot: Encoding Images From Arbitrary Camera Rigs by Implicitly Unprojecting to 3D”, in European Conference on Computer Vision. Springer, 2020, pp. 194-210 or [Online], [Retrieved on Feb. 16, 2024], Internet URL: https://arxiv.org/pdf/2008.05711v1.pdf).

In the LSS algorithm, first, two-dimensional images are acquired by the respective cameras 300A to 300F. The feature vectors of the multiple two-dimensional images are extracted using a machine learning model such as CNN. The depth of each pixel is estimated for each of the two-dimensional images captured by the respective cameras. Since the estimated depth is ambiguous, a probability distribution of discrete depths is predicted for each pixel, assuming a ray (a ray from the camera to a point in the three-dimensional space) corresponding to that pixel. A cross product of the predicted discrete depth probability distribution and the feature vector is calculated to obtain a series of points as information representing the depth of the pixel. As a result, a frustum-shaped point cloud is generated for each camera. The BEV feature is generated from the frustum-shaped point cloud using the intrinsic and extrinsic parameters of the camera.

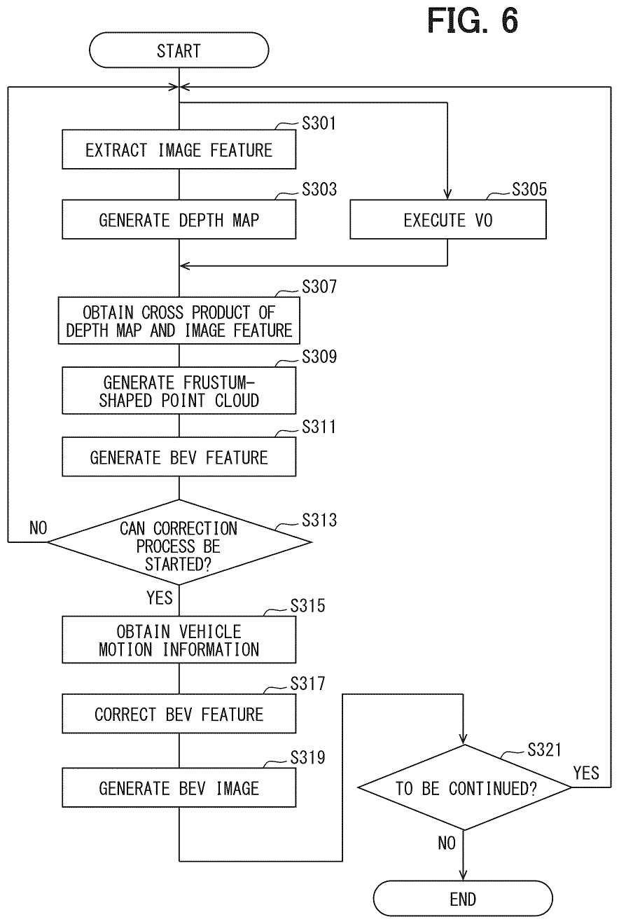

FIG. 6 shows a bird's-eye view estimation method executed by the estimation device 100 according to the present embodiment. For example, when the autonomous driving function is enabled, the process shown in FIG. 6 is started. While the following process is being executed, the cameras 300A to 300F each capture images of a predetermined range outside the vehicle 50 at a predetermined frame rate, and output the captured two-dimensional images to the estimation device 100. The two-dimensional images captured by the cameras 300A to 300F are sequentially stored in the memory 110.

In S301, the feature obtaining unit 220 extracts image features of the two-dimensional images. Specifically, image features (feature vectors) of the two-dimensional images captured by the camera 300A are extracted using a machine learning model such as CNN. The extracted image features of the two-dimensional images are stored in the memory 110. To extract the image features of the two-dimensional images captured by the camera 300A, a machine learning model that has been trained to output, when the two-dimensional image are input, image features of the two-dimensional image is used. This machine learning model is generated by machine learning using, as learning data, two-dimensional images captured by a camera attached in a similar position to the camera 300A. Further, the image features of the two-dimensional images captured by the cameras 300B to 300F are extracted using the machine learning models, which have been correspondingly trained for the respective cameras 300B to 300F, by inputting the two-dimensional images captured by the cameras 300B to 300F thereto. The extracted image features of the two-dimensional images are stored in the memory 110. In S301, 1×1 convolution is performed to extract the image features (feature vectors). Therefore, the size of the two-dimensional image is not changed.

In S301, the image features of one set of two-dimensional images may be extracted. The one set of the two-dimensional images includes six two-dimensional images captured at the same time by the cameras 300A to 300F.

Alternatively, in S301, the image feature extraction processing may be performed on two-dimensional images that are included in a predetermined number of sets of two-dimensional images stored in the memory 110 and have not been subjected to the image feature extraction processing.

In S303, a depth map is generated. Specifically, first, the position calculation unit 210 executes the VO. In this case, the three-dimensional coordinates of objects around the vehicle 50 in the world coordinate system are calculated by the VO based on the two-dimensional images captured by the cameras 300A to 300F.

Thereafter, the feature obtaining unit 220 generates the depth map using the three-dimensional coordinates in the world coordinate system of the feature points in the two-dimensional image and the two-dimensional image used to calculate the three-dimensional coordinates. In this case, the depth maps are generated for the two-dimensional images captured by the cameras 300A to 300F, respectively. In the present embodiment, the coordinates are estimated by a feature based method. For this reason, the coordinates in the world coordinate system are estimated only for the feature points detected from the corresponding images. Therefore, the coordinates in the world coordinate system are not estimated for pixels other than the feature points. The depth of pixels other than the feature points can be obtained by, for example, linear interpolation using the depths of neighboring pixels.

In S303, the depth map may be generated for one set of two-dimensional images. The one set of the two-dimensional images includes six two-dimensional images captured at the same time by the cameras 300A to 300F. Alternatively, the depth map may be generated for two or more sets of two-dimensional images.

In S305, the position calculation unit 210 executes the VO. In the present embodiment, the position and orientation of the camera 300A in the world coordinate system are calculated by the VO based on the two-dimensional image captured by the camera 300A. The processing of S301 and S303 and the processing of S305 are executed in parallel.

In S307, the feature obtaining unit 220 obtains the cross product of the image features (feature vectors) extracted from the two-dimensional images in S301 and the depth map generated in S303 as a cross product feature.

In S309, similarly to the LSS algorithm, the feature obtaining unit 220 generates the frustum-shaped point cloud based on the cross product feature obtained in S307. Specifically, a probability distribution of discrete depths is predicted for each pixel, assuming a ray (a ray from the camera to a point in the three-dimensional space) corresponding to each pixel in each two-dimensional image. The cross product of the predicted discrete depth probability distribution and a vector representing the cross product feature is calculated as the depth. The frustum-shaped point cloud is generated for the two-dimensional images acquired by each camera, by using the estimated depth, the coordinates of each pixel of the two-dimensional image, and the intrinsic and extrinsic parameters of the camera.

In S311, similarly to the LSS algorithm, the feature obtaining unit 220 generates the BEV features from the frustum-shaped point clouds generated in S309. The generated BEV features are stored in the memory 110.

In S313, it is determined whether or not the correction process by the correction unit 225 can be started. The conditions for determining whether or not the correction process can be started are the same as those in the first embodiment.

When it is determined that the correction process can be started (S313: YES), the processing of S315 is executed. When it is not determined that the correction process can be started (S313: NO), the processing of S301 and S305 are executed again.

In S315, similarly to the first embodiment (see S109 in FIG. 4), the correction unit 225 acquires motion information of the vehicle 50.

In S317, the correction unit 225 corrects the BEV features, similarly to the first embodiment (see S111 in FIG. 4).

In S319, the bird's-eye view generation unit 230 generates a bird's-eye-view image based on the BEV features. The generated bird's-eye-view image is displayed, for example, on a monitor device provided in the vehicle 50.

In S321, it is determined whether or not to continue the process according to a predetermined condition. For example, when the autonomous driving function is being enabled, it is determined that the process is to be continued (S321; YES). In this case, the processing of S301 and S305 are executed again. For example, in a state where an abnormality in the sensor is detected, it is determined not to continue the process (S321: NO). In this case, the process shown in FIG. 6 ends. The processing of S321 is executed by, for example, the bird's-eye view generation unit 230.

In the present embodiment, as described above, the position and orientation of the vehicle 50 are estimated by the VO using the images acquired by the camera that is less affected by communication delays, as compared to sensors connected to the ECU via a CAN bus, and the BEV features are corrected by using the information representing the estimated position and orientation. This method can reduce the influence of synchronization errors, as compared to a method in which the BEV features are corrected using detection values by the sensors connected to the ECU via the CAN bus.

### Fourth Embodiment

A driving assistance system 1 according to a fourth embodiment will be hereinafter described. The following description will focus on configurations that differ from the first embodiment. Description of configurations similar to those of the first embodiment will be omitted.

In the fourth embodiment, similarly to the first embodiment, a bird's-eye image is generated by combining the estimation results of the three-dimensional coordinates of objects around the vehicle 50 by the VO with the algorithm disclosed in US2023/0053785A1.

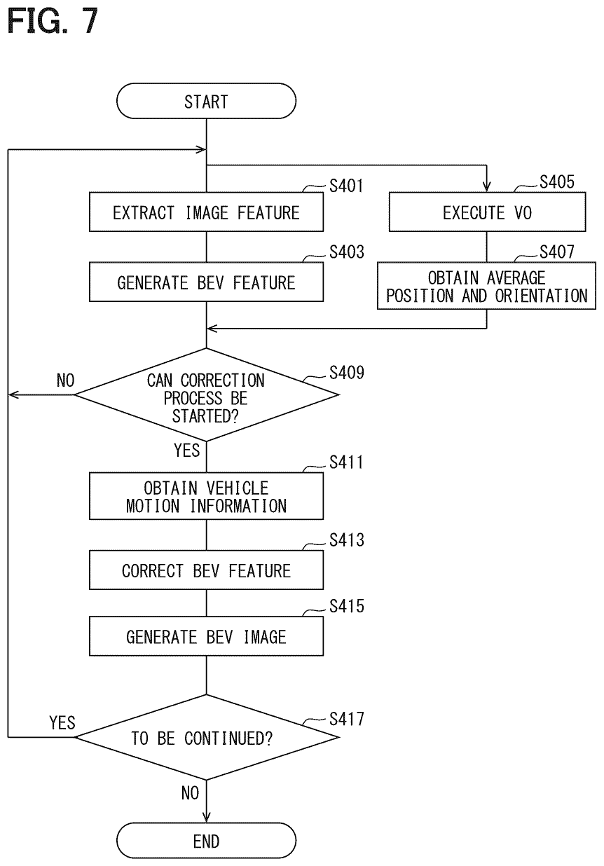

FIG. 7 shows a bird's-eye view estimation method executed by the estimation device 100 according to the present embodiment. While the following process is being executed, the cameras 300A to 300F each capture images of a predetermined range outside the vehicle 50 at a predetermined frame rate, and output the captured two-dimensional images to the estimation device 100. The two-dimensional images captured by the cameras 300A to 300F are sequentially stored in the memory 110.

In S401, similarly to the first embodiment (see S101 in FIG. 4), the feature obtaining unit 220 extracts the image features of the two-dimensional images, and the extracted image features of the two-dimensional image are stored in the memory 110.

In S401, the image features of one set of two-dimensional images may be extracted. Alternatively, the image feature extraction processing may be performed on two-dimensional images that are included in a predetermined number of sets of two-dimensional images stored in the memory 110 and which have not been subjected to the image feature extraction processing.

In S403, the feature obtaining unit 220 generates the BEV features in the BEV space using the transformer engine based on the image features of the respective two-dimensional images acquired by the cameras 300A to 300F. The generated BEV features are stored in the memory 110.

In S405, the position calculation unit 210 executes the VO. In the present embodiment, the position and orientation of each of the cameras 300A to 300F in the world coordinate system are calculated by the VO based on the two-dimensional images captured by each of the cameras 300A to 300F.

In S405, the positions and orientations of the vehicle 50 at two or more consecutive times may be calculated.

In S407, the positions and orientations of the cameras 300A-300F are averaged. In the present embodiment, the determined averages of the positions and orientations are treated as the position and orientation of the vehicle 50. In the first embodiment, the position and orientation of the camera 300A are treated as the position and orientation of the vehicle 50. Alternatively, in the present embodiment, the averages of the positions and orientations of the cameras 300A to 300F are treated as the position and orientation of the vehicle 50. The processing of S401 and S403 and the processing of S405 and S407 are executed in parallel.

In S407, the averages of the positions and orientations of the cameras 300A to 300F at two or more consecutive times may be calculated.

In S409, it is determined whether or not the correction process by the correction unit 225 can be started. The conditions for determining whether or not the correction process can be started are the same as those in the first embodiment.

In S411, similarly to the first embodiment (see S109 in FIG. 4), the correction unit 225 obtains the motion information of the vehicle 50.

In S413, the correction unit 225 corrects the BEV features, similarly to the first embodiment (see S111 in FIG. 4).

In S415, the bird's-eye view generation unit 230 generates a bird's-eye-view image based on the BEV features. The generated bird's-eye-view image is displayed, for example, on a monitor device provided in the vehicle 50.

In S417, it is determined whether or not to continue the process according to a predetermined condition. For example, when the autonomous driving function is being enabled, it is determined that the process is to be continued (S417: YES). In this case, the processing of S401 and the processing of S405 are executed again. For example, when the vehicle 50 stops traveling, it is determined not to continue the process (S417: NO). In this case, the process shown in FIG. 7 ends. The processing of S417 is executed by, for example, the bird's-eye view generation unit 230.

In the present embodiment, the position and orientation of each camera are determined based on two-dimensional images captured by the multiple cameras, and the averages of the positions and orientations of the multiple cameras are regarded as the position and orientation of the vehicle 50. For example, there are cases where a sufficient number of feature points outside the vehicle 50 cannot be detected using only a camera such as the camera 300A that captures an image of the area in front of the vehicle 50. In such a case, the accuracy of estimating the position and orientation of the vehicle 50 can be improved by averaging the positions and orientations of the multiple cameras.

### Fifth Embodiment

A driving assistance system 1 according to a fifth embodiment will be hereinafter described. The following description will focus on configurations that differ from the first embodiment. Description of configurations similar to those of the first embodiment will be omitted.

In the present embodiment, the position calculation unit 210 calculates the position and orientation of the vehicle 50 based on sequential two-dimensional images, using a visual inertial odometry (VIO) as a self-position estimation method. In this case, it is assumed that the vehicle 50 is equipped with an IMU.

In the VIO, the position and orientation of the vehicle 50, the three-dimensional coordinates of objects around the vehicle 50, and the synchronization error between the camera and the IMU equipped to the vehicle 50 are calculated using images captured by the camera and detection values from the IMU. As the method for the VIO, for example, a known technique (Tong Qin, and Shaojie Shen, “Online Temporal Calibration for Monocular Visual-Inertial Systems”, IEEE International Workshop on Intelligent Robots and Systems (IROS), [online], [Retrieved on Sep. 4, 2023], Internet URL: https://doi.org/10.1109/iros.2018.8593603) can be used.

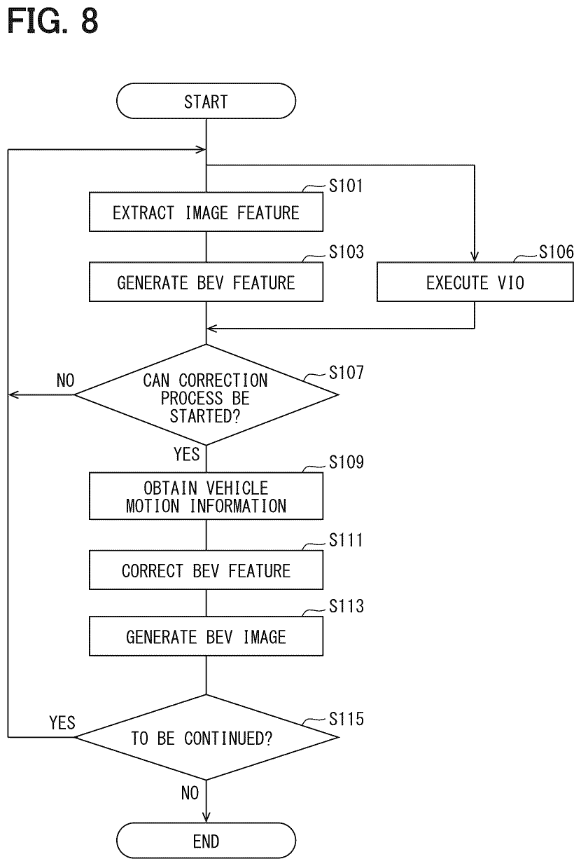

FIG. 8 shows a bird's-eye view estimation method executed by the estimation device 100 according to the present embodiment. In FIG. 8, the same processing as that in the first embodiment (see FIG. 4) is denoted by the same reference numeral. For example, when the autonomous driving function is enabled, the process shown in FIG. 8 is started. While the following process is being executed, the cameras 300A to 300F each capture images of a predetermined range outside the vehicle 50 at a predetermined frame rate, and output the captured two-dimensional images to the estimation device 100. The two-dimensional images captured by the cameras 300A to 300F are sequentially stored in the memory 110.

In S101, similarly to the first embodiment, the feature obtaining unit 220 extracts the image features (feature vectors) of the two-dimensional images acquired by the camera 300A. The extracted image features of the two-dimensional images are stored in the memory 110.

In S103, similarly to the first embodiment, the feature obtaining unit 220 generates the BEV features based on the image features of the respective two-dimensional images acquired by the cameras 300A to 300F. The generated BEV features are stored in the memory 110.

In S106, the position calculation unit 210 executes the VIO. In the present embodiment, the position and orientation of the camera 300A in the world coordinate system are calculated by the VIO for the two-dimensional image captured by the camera 300A. The calculated position and orientation of the camera 300A are treated as the position and orientation of the vehicle 50. The processing of S101 and S103 and the processing of S106 are executed in parallel.

In S106, the position and orientation of the vehicle 50 at two or more consecutive times may be calculated.

The processing on and after step S107 are similar to those in the first embodiment, and therefore the description thereof will be omitted.

In the present embodiment, in addition to the two-dimensional images, measurement values from the inertial measurement unit are used in order to estimate the position and orientation of the vehicle 50, so that more reliable results can be obtained in estimating the position and orientation of the vehicle 50.

### Sixth Embodiment

A driving assistance system 1 according to a sixth embodiment will be hereinafter described. The following description will focus on configurations that differ from the first embodiment. Description of configurations similar to those of the first embodiment will be omitted.

In any of the first to fourth embodiments, the VIO can be used as the self-position estimation method. In addition, in any of the first to fourth embodiments, the VIO together with a wheel speed sensor can be used as the self-position estimation method. In general, in the VIO, an estimation error tends to be large immediately after the vehicle starts moving from a stopped state because it is difficult for the VIO to distinguish between a change in acceleration due to the acceleration of the vehicle and a change in orientation. By adding the wheel speed sensor, the estimation error of the vehicle position and orientation by the VIO can be reduced. In this case, it is assumed that the vehicle 50 is equipped with the wheel speed sensor. Since the measurement values from the inertial measurement unit and the detection values from the wheel speed sensor are used, in addition to the two-dimensional image, to estimate the position and orientation of the vehicle 50, it is possible to obtain more reliable results in estimating the position and orientation of the vehicle 50.

### Seventh Embodiment

A driving assistance system 1 according to the seventh embodiment will be hereinafter described. The following description will focus on configurations that differ from the first embodiment. Description of configurations similar to those of the first embodiment will be omitted.

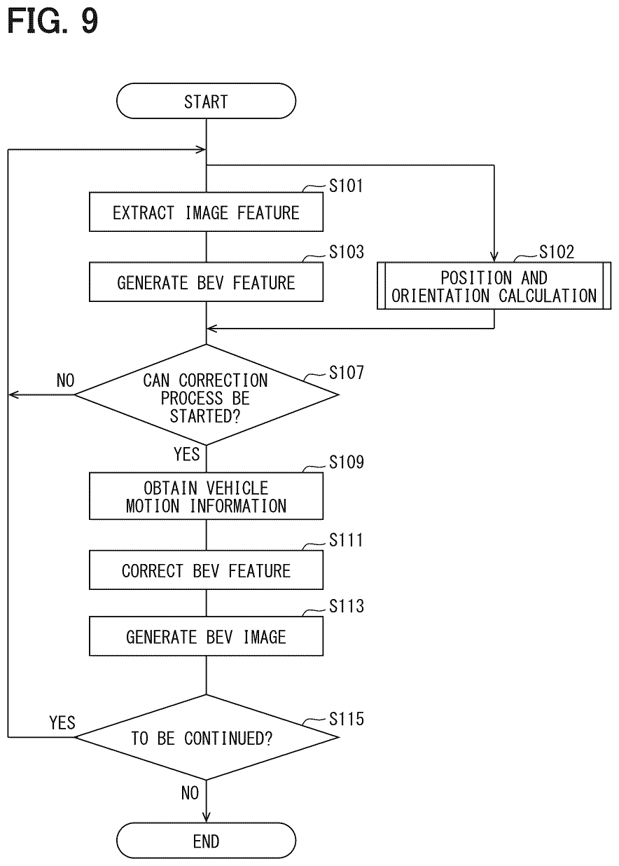

FIG. 9 shows a bird's-eye view estimation method executed by the estimation device 100 according to the present embodiment. In FIG. 9, the same processing as that in the first embodiment (see FIG. 4) is denoted by the same reference numeral. While the following process is being executed, the cameras 300A to 300F each capture images of a predetermined range outside the vehicle 50 at a predetermined frame rate, and output the captured two-dimensional images to the estimation device 100. The two-dimensional images captured by the cameras 300A to 300F are sequentially stored in the memory 110.

The processing in S101 and S103 are similar to those in the first embodiment, and therefore the description thereof will be omitted.

In S102, the position and orientation calculation process is executed. The processing of S101 and S103 and the processing of S102 are executed in parallel.

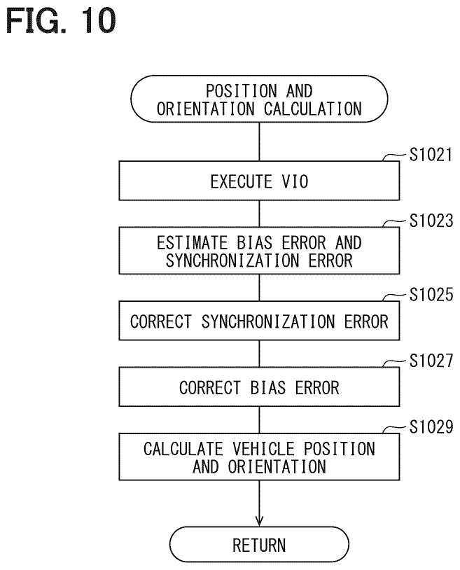

FIG. 10 shows a flowchart of the position and orientation calculation process in FIG. 9. In S1021, the position calculation unit 210 executes the VIO. In the present embodiment, the measurement values by the inertial measurement unit and the detection values by the wheel speed sensor are used.

In the present embodiment, the position and orientation of the camera 300A in the world coordinate system are calculated by the VIO for the two-dimensional images captured by the camera 300A. The calculated position and orientation of the camera 300A are treated as the position and orientation of the vehicle 50. By executing the VIO, the position T and orientation R of the vehicle 50 in the world coordinate system, and the three-dimensional coordinates X_{W} of the set of feature points are calculated.

In S1023, the position calculation unit 210 estimates a bias error and a synchronization error. Specifically, the bias error of the IMU is estimated based on the position T and orientation R of the vehicle 50 and the three-dimensional coordinates X_{W} of the set of feature points. A known estimation method is used to estimate the bias error. Further, the synchronization error between the camera and the IMU is estimated based on the position T and orientation R of the vehicle 50 and the three-dimensional coordinates X_{W} of the set of feature points. A known estimation method is used to estimate the synchronization error.

In S1025, the position calculation unit 210 corrects the synchronization error. Specifically, using the synchronization error estimated in S1023, a detection value synchronized with the two-dimensional image acquired by the camera 300A is selected from the sequential detection values of the IMU.

In S1027, the position calculation unit 210 corrects the detection value of the IMU selected in S1025 using the bias error estimated in S1023.

In S1029, the position calculation unit 210 calculates the position and orientation of the vehicle 50 based on the detection value of the IMU whose bias error has been corrected in S1027. The position and orientation calculation process is executed in this way. In the present embodiment, the position and orientation of the vehicle 50 are calculated based on the detection value of the IMU. Thereafter, the processing on and after S107 shown in FIG. 9 are executed.

As shown in FIG. 9, in S107, it is determined whether or not the correction unit 225 can start the correction process. The correction process can be started when all of the following conditions (i) to (iv) are satisfied. (i) The BEV features have been generated based on the image features of the current frame acquired by the cameras 300A to 300F, respectively. (ii) The BEV features have been generated based on the image features of the previous frame acquired by the cameras 300A to 300F, respectively. (iii) The position and orientation of the vehicle 50 at the time the current frame was acquired have been calculated. (iv) The position and orientation of the vehicle 50 at the time the previous frame was acquired have been calculated.

When it is determined that the correction process can be started (S107: YES), the processing of S109 is executed. When it is not determined that the correction process can be started (S107; NO), the processing of S101 and S105 are executed again.

In S109, the correction unit 225 obtains motion information of the vehicle 50. The motion information of the vehicle 50 represents the amounts of change of the position and orientation of the vehicle 50 between those at the time the current frame is acquired and those at the time the previous frame is acquired. As described above, the position and orientation of the vehicle 50 are calculated based on the measurement values of the IMU.

The processing on and after S111 are similar to those in the first embodiment, and therefore the description thereof will be omitted.

In the VIO, the estimation results of the position and orientation of the vehicle 50 based on the two-dimensional images acquired by the camera and the estimation results of the position and orientation of the vehicle 50 based on the detection values by the IMU are integrated. Since the angular velocity information output by the IMU contains the bias error, if the period during which position and orientation are estimated extends over a long period of time, the error in the estimation results due to the bias error of the IMU will become large. When the two-dimensional image acquired by a camera is used to estimate the position and orientation, the estimation result contains errors due to the influence of blur contained in the two-dimensional image. Therefore, if the period during which the position and orientation are estimated is short, the accuracy of the estimation result will be low. On the other hand, since there is no bias error in two-dimensional images acquired by a camera, the accuracy of the estimation results is high when the period during which the position and orientation are estimated extends over a long period of time.

In consideration of the above characteristics, in the present embodiment, the bias error of the detection value of the IMU is estimated using the estimation result of the VIO. After correcting bias errors in the IMU detection values, the position and orientation of the vehicle 50 are calculated based on the IMU detection values. In this way, the issues caused by the characteristics of each sensor described above are resolved.

### Eighth Embodiment

A driving assistance system 1 according to the eighth embodiment will be described below. The following description will focus on configurations that differ from the first embodiment. Description of configurations similar to those of the first embodiment will be omitted.

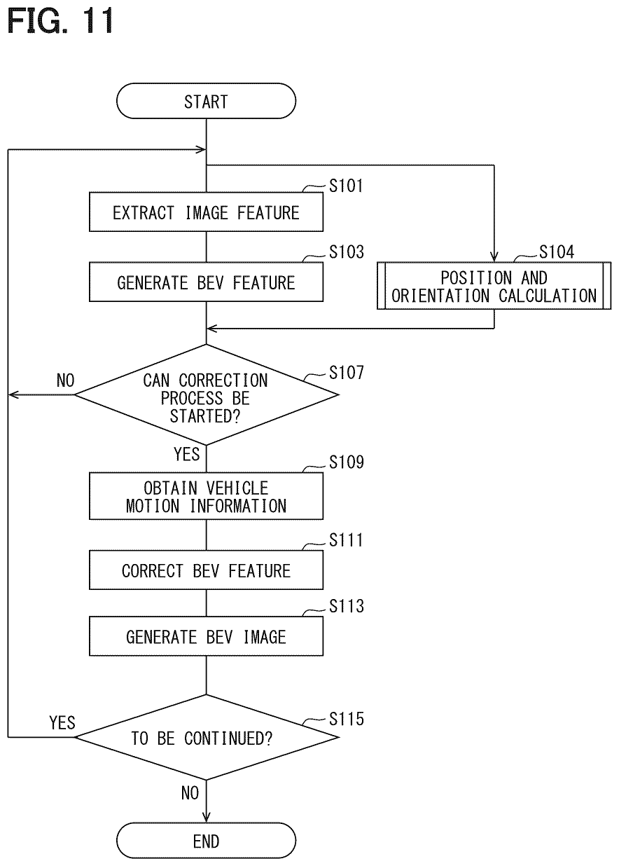

FIG. 11 shows a bird's-eye view estimation method executed by the estimation device 100 according to the present embodiment. In FIG. 11, the same processing as that in the first embodiment (see FIG. 4) is denoted by the same reference numeral. While the following process is being executed, the cameras 300A to 300F each capture images of a predetermined range outside the vehicle 50 at a predetermined frame rate, and output the captured two-dimensional images to the estimation device 100. The two-dimensional images captured by the cameras 300A to 300F are sequentially stored in the memory 110.

The processing of S101 and the processing of S103 are similar to those in the first embodiment, and therefore the description thereof will be omitted.

In S104, the position and orientation calculation process is executed. The processing of S101 and S103 and the processing of S104 are executed in parallel.

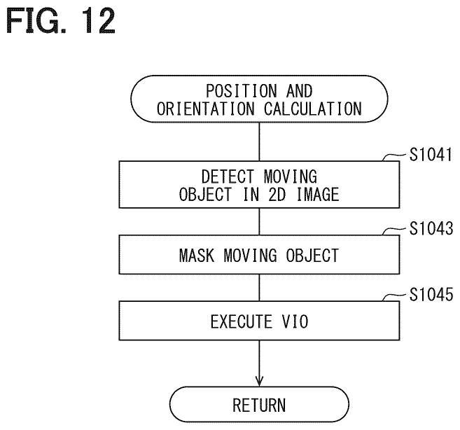

FIG. 12 shows a flowchart of the position and orientation calculation process in FIG. 11. In S1041, the position calculation unit 210 detects a moving object included in the two-dimensional image that is captured by the camera 300A and is subjected to the extraction process of the image features in S101. For example, a moving object is detected using a machine learning model such as Pseudo-LiDAR. Alternatively, a moving object may be detected using a known method for detecting a moving object that utilizes epipolar geometry.

In S1043, the position calculation unit 210 executes a masking on the two-dimensional image of the target. The target two-dimensional image is the two-dimensional image from which the image features have been extracted in S101.

In S1045, the position calculation unit 210 executes the VIO. In this case, the VIO is executed based on the two-dimensional image masked in S1043. By executing the VIO, the position T and orientation R of the vehicle 50 in the world coordinate system, and the three-dimensional coordinates X_{W} of the set of feature points are calculated. The position and orientation calculation process of the present embodiment is executed in this way. Thereafter, the processing on and after S107 shown in FIG. 11 are executed.

The processing on and after S107 shown in FIG. 11 are similar to those in the first embodiment, and therefore the description thereof will be omitted.

When estimating the position and orientation of the vehicle 50 by the VIO, it is desirable that objects around the vehicle 50 are stationary. When other vehicles, pedestrians and the like around the host vehicle 50 are moving, the error contained in the estimation result by the VIO tends to be large. For this reason, in the present embodiment, a moving object is detected in advance in a two-dimensional image, and the VIO is executed based on the two-dimensional image in which the detected moving object is masked. Therefore, the error contained in the estimation result by the VIO can be reduced.

### Other Embodiments

While the exemplary embodiments and examples have been chosen to illustrate the present disclosure, it will be apparent to those skilled in the art from this disclosure that various changes and modifications can be made therein without departing from the scope of the disclosure as defined in the appended claims. For example, the embodiments described above may be modified as follows.

### Modified Embodiment 1

In the first embodiment, an example in which the coordinates of objects around the vehicle 50 are estimated using the feature based method have been described. Alternatively, the coordinates of objects around the vehicle 50 may be estimated by a direct method. For example, the depths of all pixels in the image can be restored by DTAM (Richard A. Newcombe and two others, “DTAM: Dense Tracking and Mapping in Real-Time”, IEEE Xplore, [online], [Retrieved on Sep. 4, 2023], Internet URL: https://doi.orq/10.1109/ICCV.2011.6126513).

### Modified Embodiment 2

In the first embodiment, an example in which the coordinates of objects around the vehicle 50 are estimated using the feature based method, and the depths of pixels other than the feature points are interpolated by linear interpolation has been described. Alternatively, the depth can be interpolated using a depth interpolation method using a machine learning model (Alex Wong, et al., “Unsupervised Depth Completion from Visual Inertial Odometry” IEEE Xplore, [online], [Retrieved on Sep. 4, 2023], Internet URL: https://doi.org/10.1109/lra.2020.2969938).

The estimation device and the method thereof according to the present disclosure may be implemented by one or more special-purposed computers. Such a special-purposed computer may be provided by configuring a processor and a memory programmed to execute one or more functions embodied by a computer program. Alternatively, the estimation device and the method thereof according to the present disclosure may be achieved by a dedicated computer provided by constituting a processor with one or more dedicated hardware logic circuits. Alternatively, the estimation device and the method thereof according to the present disclosure may be achieved using one or more dedicated computers constituted by a combination of a processor and a memory programmed to execute one or more functions and a processor formed of one or more hardware logic circuits. The computer program may be stored, as instructions to be executed by a computer, in a tangible non-transitory computer-readable medium.

The present disclosure should not be limited to the embodiments described above, and various other embodiments may be implemented without departing from the scope of the present disclosure. For example, the technical features in the embodiments corresponding to the technical features in the aspects described in the summary of the invention can be replaced or combined as appropriate. Also, if the technical features are not described as essential in the present specification, they can be deleted as appropriate.

What is claimed is:

1. An estimation device comprising:
a position calculation unit configured to calculate a position and an orientation of a vehicle, using a self-position estimation method including a visual odometry, based on sequential two-dimensional images representing outside of the vehicle captured by a same camera, which is at least one of a plurality of cameras mounted on the vehicle;
a feature obtaining unit configured to obtain a bird's-eye view (BEV) feature, which is a feature in a BEV space, based on the two-dimensional images representing outside of the vehicle using a BEV estimation algorithm; and
a correction unit configured to correct the BEV feature obtained by the feature obtaining unit using information representing the position and the orientation.

2. The estimation device according to claim 1, wherein
the BEV estimation algorithm is configured to:
generate image features, which are features of the two-dimensional images, by inputting the two-dimensional images captured by each of the plurality of cameras into a corresponding one of a plurality of machine learning models, the plurality of machine learning models having been trained correspondingly to the plurality of cameras to take therein the two-dimensional images captured by the corresponding cameras as input and output the image features;
generate a frustum feature for each of the plurality of cameras based on the image features of the two-dimensional images captured by a corresponding one of the plurality of cameras; and
convert the frustum feature generated for each of the plurality of cameras into the BEV feature.

3. The estimation device according to claim 2, wherein
the position calculation unit is configured to use the self-position estimation method including a visual inertial odometry.

4. The estimation device according to claim 2, wherein
the position calculation unit is configured to further use a detection value of a wheel speed sensor to calculate the position and the orientation of the vehicle.

5. The estimation device according to claim 1, wherein
the BEV estimation algorithm is configured to:
generate image features, which are features of the two-dimensional images, by inputting the two-dimensional images captured by each of the plurality of cameras into a corresponding one of a plurality of machine learning models, the plurality of machine learning models having been trained correspondingly to the plurality of cameras to take therein the two-dimensional images captured by the corresponding cameras as input and output the image features; and
generate the BEV feature by converting the image features of each of the plurality of cameras from an image space into the BEV space, based on the image features of a corresponding one of the plurality of cameras previously acquired and the image features of the corresponding one of the plurality of cameras currently acquired, using a machine learning model having an attention mechanism.

6. The estimation device according to claim 5, wherein
the position calculation unit is configured to use the self-position estimation method including a visual inertial odometry.

7. The estimation device according to claim 5, wherein
the position calculation unit is configured to further use a detection value of a wheel speed sensor to calculate the position and the orientation of the vehicle.

8. A method for estimating a bird's-eye view, comprising:
calculating a position and an orientation of a vehicle, using a self-position estimation method including a visual odometry, based on sequential two-dimensional images of outside of the vehicle captured by a same camera, which is at least one of a plurality of cameras provided on the vehicle;
obtaining a bird's-eye view (BEV) feature, which is a feature in a BEV space based on the two-dimensional images representing outside of the vehicle using a BEV estimation algorithm; and
correcting the obtained BEV feature using information representing the position and the orientation.

9. An estimation device for estimating a bird's-eye view comprising a processor and a memory storing instructions that, when executed by the processor, causes the processor to perform operations including:
calculating a position and an orientation of a vehicle, using a self-position estimation method including a visual odometry, based on sequential two-dimensional images representing outside of the vehicle captured by a same camera, which is at least one of a plurality of cameras mounted on the vehicle;
obtaining a bird's-eye view (BEV) feature, which is a feature in a BEV space, based on the two-dimensional images representing outside of the vehicle using a BEV estimation algorithm; and
correcting the obtained BEV feature using information representing the position and the orientation.
